(19) United States
(12) Patent Application Publication
(10) Pub. No.: US 2019/0308916 A1
(43) Pub. Date: Oct. 10, 2019

(54) CONTROLLED-RELEASE OF FERTILIZER COMPOSITIONS AND USES THEREOF

(71) Applicants: SABIC Global Technologies B.V., Bergen op Zoom (NL); NINGBO INSTITUTE OF MATERIALS TECHNOLOGY AND ENGINEERING CHINESE ACADEMY OF SCIENCES, Taiyuan (CN)

(72) Inventors: Jian Zhang, Taiyuan (CN); Yexin Zhang, Taiyuan (CN); Hui Chen, Taiyuan (CN); Yunyang Liu, Thuwal (SA); Ihab N. Odeh, Sugar Land, TX (US); Xufeng Zhou, Taiyuan (CN); Zhaoping Liu, Taiyuan (CN)

(21) Appl. No.: 16/464,732

(22) PCT Filed: Nov. 22, 2017
(86) PCT No.: PCT/IB2017/057343

§ 371 Date: May 29, 2019

(30) Foreign Application Priority Data
Nov. 29, 2016 (CN) 201611073618.6

(51) Int. Cl. C05G 3/00; C05C 9/00; A01C 21/00

(52) U.S. Cl. CPC C05G 3/0082; A01C 21/00; C05C 9/00; C05G 3/0047

(57) ABSTRACT

A controlled-release fertilizer composition, methods of making, and uses thereof are described. The controlled-release fertilizer composition includes a composite graphene-carbon nanotube material having a three-dimensional open-celled network of graphene and carbon nanotubes and a fertilizer impregnated in the three-dimensional open-celled network of graphene and carbon nanotubes.

### CROSS REFERENCE TO RELATED APPLICATIONS

This application claims the benefit of priority of Chinese Patent Application No. 201611073618.6 filed Nov. 29, 2016, which is hereby incorporated by reference in its entirety.

### BACKGROUND OF THE INVENTION

### A. Field of the Invention

The invention generally concerns a controlled-release fertilizer composition. The controlled-release fertilizer composition can include fertilizer impregnated into a composite graphene-carbon nanotube material having a three-dimensional open-celled network of graphene and carbon nanotubes. This network can provide high fertilizer absorption and excellent thermal conductivity for efficient temperature-dependent release of the fertilizer.

### B. Description of Related Art

Fertilizers are extensively used in the agricultural industry to provide plants with nitrogen and essential nutrients, such that an estimated 30 to 50% of agriculture yields can be attributed to natural or synthetic commercial fertilizers. Nonetheless, current fertilizer use has many drawbacks. First, as modern agriculture relies increasingly on non-renewable fertilizer resources future feedstocks are likely to yield lower quality at higher prices. Second, fertilizers tend to leach away or volatilize during the application process, which can contribute to waste of energy and resources. Leaching and volatilization can also contribute to water pollution, agricultural product contamination, and the greenhouse effect. Third, some of the nutrients in non-renewable fertilizers that are not absorbed by plants can leach into groundwater or surface water, leading to eutrophication, which can impose further risks to the ecosystem.

To increase the efficiency of fertilizer use, efforts towards developing new renewable technologies for delivering plant nutrients in a slow- or controlled-manner in water or soil have been extensive. Conventional methods to control the release of fertilizers include coating fertilizer particles with a film that is relatively insoluble in water. The release of the fertilizer can be controlled through the film's permeability, with the goal of one application satisfying the nitrogen demand throughout the entire crop growth season, and reduction of nitrogen loss due to decomposition, volatilization, and leaching. By way of example Ko et al. (“Controlled Release of Urea from Rosin-Coated Fertilizer Particles”, Industrial & Engineering Chemistry Research, 1996, 35:250-7) describes using rosin coated urea particles for sustained release of fertilizer. Zhang et al. (“Slow-release fertilizer encapsulated by graphene oxide films”, Chemical Engineering Journal 2014, 255:107-13) describes potassium nitrate particles coated with graphene oxide film for sustained release of the potassium nitrate. International Patent Application No. WO2015066691 to Gao et al., describes a slow-release fertilizer composition that includes fertilizer particles coated with graphene/graphene oxide/reduced-graphene oxide thin films.

Other attempts to coat fertilizer particles include encapsulating the fertilizer in a water-soluble polymer-carbon nanotube shell or a graphene oxide shell. By way of example, Chinese Patent Application CN104826340 to Lu et al., describes a microencapsulated graphene composite material, which permits the sustained and stable release of fertilizers and pesticides over the entire growing season. Chinese Patent Application CN104276877 to Changwen et al., describes encapsulating fertilizer in a carbon nanotube modified water-based polymer composite-coated shell.

Coated and encapsulated fertilizer particles suffer due to uncontrollable breakdown or degradation of the coating or shell, resulting in uncontrolled release of fertilizer into the environment (e.g., soil, water, or the like). Since a plant root system cannot quickly absorb all of the released fertilizer, volatilization or decomposition of the fertilizer can occur, resulting in loss of nutrients. As discussed above, efforts to develop better fertilizer utilization rates, mitigate or eliminate fertilizer pollution, while developing sustainable and efficient agriculture have been extensive. However, many of the produced compositions are ineffective and/or costly to manufacture.

### SUMMARY OF THE INVENTION

A discovery has been made that offers a solution to some of the aforementioned problems associated with coated or encapsulated controlled-release fertilizers. The solution is premised on impregnating fertilizer within a composite graphene-carbon nanotube material having a three-dimensional open-celled network. In particular, the three-dimensional open-celled network offers advantages ranging from high specific surface area, excellent thermal and electrical conductivity, and/or excellent mechanical properties. These advantages can result in a controlled or sustained release of fertilizer from the composite graphene-carbon nanotube material under specific release conditions (e.g., temperature of soil) while reducing or avoiding the degradation issues currently associated with coated or encapsulated fertilizers. In some embodiments, the graphene-carbon nanotube composite can be a monolithic open-celled foam network having a plurality of pores and channels. This three-dimensional network of pores and channels can be in mutual communication, which can further promote thermal conductivity. In particular, this thermal conductivity can effectively enhance absorption and release of fertilizers from the three-dimension network of pores and channels. The increased thermal conductivity can provide an effective control of fertilizer release that can be modulated by the ambient temperature of the soil. Advantages of the fertilizer composition of the present invention can include (1) high fertilizer content, including 10 wt. % to 95 wt. % of fertilizer, based on the total weight of the controlled-release fertilizer composition and/or (2) controlled and stable release of fertilizer in soil, preferably in soil at a depth of at least 2 centimeters (cm) from the soil surface, or most preferably in soil at a depth of 5 cm to 12 cm from the soil surface.

In an embodiment of the present invention controlled-release fertilizer composition is described. The controlled-release fertilizer composition can include (a) a composite graphene-carbon nanotube material having a three-dimensional open-celled network of graphene and carbon nanotubes, and (b) a fertilizer impregnated within the three-dimensional open-celled network of graphene and carbon nanotubes. In one aspect, the mass ratio of graphene to carbon nanotubes can be 0.1:1 to 5:1, preferably 0.5:1 to 2:1. In other aspects, the composite graphene-carbon nanotube material can be a monolith network of graphene and carbon nanotubes having an open-celled foam structure. The controlled-release three-dimensional open-celled network can include interconnected pores and channels, and the diameter of the pores and channels can range from 1 to 100 microns, preferably from 2 to 50 microns. In a particular aspect, the graphene contained in the composite graphene-carbon nanotube material of the present invention includes a plurality of planar graphene sheets while the carbon nanotubes can be single walled carbon nanotubes, multi-walled carbon nanotubes, or a combination thereof, preferably multi-walled carbon nanotubes. In a non-limiting aspect, the graphene and carbon nanotubes that make up the composite graphene-carbon nanotube material of the present invention can be coupled or bound by van der Waal forces. The composite graphene-carbon nanotube material can be prepared by lyophilizing an aqueous mixture having a plurality of planar graphene sheets and a plurality of multi-walled carbon nanotubes to produce a three-dimensional composite material having an open-celled network of pores and channels. These pores and channels can provide spaces for the fertilizer to be positioned in (e.g., impregnating the composite material with fertilizer). This manufacturing process can provide an effective temperature controlled-release fertilizer composition. In some instances, the fertilizer impregnated within the three-dimensional open-celled network can be controllably released from the composite graphene-carbon nanotube material in response to at least temperature. The release temperature of the fertilizer can be 0° C. to 40° C., preferably 10° C. to 30° C. In other instances, the composite graphene-carbon nanotube material can have thermal conductivity of at least 0.2 milliwatts per meter Kelvin (mW/m.≠K) at a temperature of 20° C. to 80° C., preferably a thermal conductivity of 0.3 mW/m.·K to 0.8 mW/m.·K at a temperature of 25° C. to 60° C. Non-limiting examples impregnated fertilizer can include urea, ammonium nitrate, calcium ammonium nitrate, one or more superphosphates, molybdenum, zinc, copper, boron, cobalt, iron, a binary nitrogen and phosphorous (NP) fertilizer, a binary nitrogen and potassium (NK) fertilizer, a binary phosphorous and potassium (PK) fertilizer, or a ternary nitrogen phosphorous, and potassium (NPK) fertilizer, or any combination thereof. In a specific aspect, the fertilizer includes urea.

Other embodiments disclose methods to fertilize soil using the controlled-release fertilizer of the present invention. A method can include applying the controlled-release fertilizer to soil. The controlled-release fertilizer can be applied to the surface of the soil, preferably applied to the soil at a depth of at least 2 cm from the soil surface, or more preferably applied to the soil at a depth of 5 cm to 12 cm from the soil surface. In one aspect, the fertilizer can be controllably released from the composite graphene-carbon nanotube material in response to at least temperature, and the release temperature of the fertilizer can be 0° C. to 40° C., preferably 10° C. to 30° C.

Still other embodiments disclose methods of making the controlled-release fertilizer. A method can include: (a) obtaining a composite graphene-carbon nanotube material having a three-dimensional open-celled network of graphene and carbon nanotubes; (b) combining the composite graphene-carbon nanotube material with an aqueous solution that includes a fertilizer for a sufficient period of time to allow the aqueous solution to infiltrate the three-dimensional open-celled network of graphene and carbon nanotubes; and (c) drying the composite graphene-carbon nanotube material from step (b) to obtain the controlled-release fertilizer of the present invention. In one aspect, steps (b) and (c) can be each performed at a temperature of 5° C. to less than 100° C., preferably 10° C. to 50° C., more preferably 15° C. to 30° C., or most preferably 20° C. to 25° C. In a preferred and convenient aspect, the composite graphene-carbon nanotube material from step (a) can be obtained by lyophilization of an aqueous mixture of graphene and carbon nanotubes.

In one aspect of the invention, 20 embodiments are described. Embodiment 1 describes a controlled-release fertilizer composition that includes (a) a composite graphene-carbon nanotube material having a three-dimensional open-celled network of graphene and carbon nanotubes, and (b) a fertilizer impregnated within the three-dimensional open-celled network of graphene and carbon nanotubes. Embodiment 2 is the controlled-release fertilizer composition of embodiment 1, wherein the mass ratio of graphene to carbon nanotubes is 0.1:1 to 5:1, preferably 0.5:1 to 2:1. Embodiment 3 is the controlled-release fertilizer composition of any one of embodiments 1 to 2, wherein the composite graphene-carbon nanotube material is a monolith network of graphene and carbon nanotubes having an open-celled foam structure. Embodiment 4 is the controlled-release fertilizer composition of any one of embodiments 1 to 3, wherein the controlled-release three-dimensional open-celled network includes pores and channels. Embodiment 5 is the controlled-release fertilizer composition of embodiment 4, wherein the diameter of the pores and channels is 1 to 100 microns, preferably 2 to 50 microns. Embodiment 6 is the controlled-release fertilizer composition of any one of embodiments 1 to 5, wherein the graphene includes a plurality of planar graphene sheets. Embodiment 7 is the controlled-release fertilizer composition of any one of embodiments 1 to 6, wherein the carbon nanotubes are single walled carbon nanotubes, multi-walled carbon nanotubes, or a combination thereof, preferably multi-walled carbon nanotubes. Embodiment 8 is the controlled-release fertilizer composition of any one of embodiments 1 to 7, wherein the fertilizer is controllably released from the composite graphene-carbon nanotube material in response to at least temperature. Embodiment 9 is the controlled-release fertilizer composition of embodiment 8, wherein the release temperature of the fertilizer is 0° C. to 40° C., preferably 10° C. to 30° C. Embodiment 10 is the controlled-release fertilizer composition of any one of embodiments 1 to 9, wherein the composite graphene-carbon nanotube material has a thermal conductivity of at least 0.2 milliwatts per meter Kelvin (mW/m.·K) at a temperature of 20° C. to 80° C., preferably a thermal conductivity of 0.3 mW/m.·K to 0.8 mW/m. K at a temperature of 25° C. to 60° C. Embodiment 11 is the controlled-release fertilizer composition of any one of embodiments 1 to 10, wherein the fertilizer includes urea, ammonium nitrate, calcium ammonium nitrate, one or more superphosphates, molybdenum, zinc, copper, boron, cobalt, iron, a binary nitrogen and phosphorous (NP) fertilizer, a binary nitrogen and potassium (NK) fertilizer, a binary phosphorous and potassium (PK) fertilizer, or a ternary nitrogen, phosphorous, and potassium (NPK) fertilizer, or any combination thereof, preferably urea. Embodiment 12 is the controlled-release fertilizer composition of any one of embodiments 1 to 11, wherein the fertilizer composition is included in soil, preferably included in soil at a depth of at least 2 centimeters (cm) from the soil surface, or most preferably included in soil at a depth of 5 cm to 12 cm from the soil surface. Embodiment 13 is the controlled-release fertilizer composition of any one of embodiments 1 to 12, including 10 wt. % to 95 wt. % of fertilizer, based on the total weight of the controlled-release fertilizer composition.

Embodiment 14 is a method of fertilizing soil, the method that includes applying the controlled-release fertilizer composition of any one of embodiments 1 to 13 to soil. Embodiment 15 is the method of embodiment 14, wherein the controlled-release fertilizer composition is applied to the surface of the soil, preferably applied to the soil at a depth of at least 2 centimeters (cm) from the soil surface, or more preferably applied to the soil at a depth of 5 cm to 12 cm from the soil surface. Embodiment 16 is the method of any one of embodiments 14 to 15, wherein the fertilizer is controllably released from the composite graphene-carbon nanotube material in response to at least temperature. Embodiment 17 is the method of embodiment 16, wherein the release temperature of the fertilizer is 0° C. to 40° C., preferably 10° C. to 30° C.

Embodiment 18 is a method of making the controlled-release fertilizer composition of any one of embodiments 1 to 13, the method can include (a) obtaining a composite graphene-carbon nanotube material having a three-dimensional open-celled network of graphene and carbon nanotubes, (b) combining the composite graphene-carbon nanotube material with an aqueous solution that includes a fertilizer for a sufficient period of time to allow the aqueous solution to infiltrate the three-dimensional open-celled network of graphene and carbon nanotubes, and (c) drying the composite graphene-carbon nanotube material from step (b) to obtain the controlled-release fertilizer composition of any one of embodiments 1 to 13. Embodiment 19 is the method of embodiment 18, wherein steps (b) and (c) are each performed at a temperature of 5° C. to less than 100° C., preferably 10° C. to 50° C., more preferably 15° C. to 30° C., or most preferably 20° C. to 25° C. Embodiment 20 is the method of any one of embodiments 18 to 19, wherein the composite graphene-carbon nanotube material from step (a) is obtained by lyophilizing an aqueous mixture of graphene and carbon nanotubes.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and/or packages of compositions of the invention can be used to achieve methods of the invention.

The following includes definitions of various terms and phrases used throughout this specification.

The term “graphene” refers to a thin sheet of carbon atoms (e.g., usually one-atom thick) arranged in a hexagonal format or a flat monolayer of carbon atoms that are tightly packed into a 2D honeycomb lattice (e.g., sp²-bonded carbon atoms). Graphene does not include graphene oxide. In the context of the present invention, “graphene” also encompasses a stack of graphene sheets or monolayers (e.g., graphene stack having 2, 3, 4, 5, 6, 7, 8, 9, or 10, or more sheets or monolayers).

The term “nanotube” refers to a tubular structure in which at least one dimension of the tubular structure is equal to or less than 1000 nm (e.g., one dimension is 1 to 1000 nm in size) and an aspect ratio greater than 1:1, preferably greater than 5:1. The “aspect ratio” of a nanotube is the ratio of the actual length (L) of the nanotube to the diameter (D) of the nanotube. Similarly, a “nanostructure” or “nanoparticle” can refer to a wire, a particle (e.g., having a substantially spherical shape), a rod, a tetrapod, a hyper-branched structure, a tube, a cube, or mixtures thereof having at least one diameter on the order of nanometers (i.e., between about 1 and 1000 nm).

The term “fertilizer” refers to any additive containing organic and/or inorganic nutrients (synthetic and/or natural), or mixtures thereof, that are added to soil to supply nutrients needed for plant growth and/or development. In embodiments of the present invention, fertilizer may include one or more nutrients (macro- and/or micro-nutrients)/Non-limiting examples of nutrients include sources of nitrogen (N), phosphorus (P), potassium (K), calcium (Ca), magnesium (Mg), and sulfur (S), boron (B), chlorine (Cl), copper (Cu), iron (Fe), manganese (Mn), molybdenum (Mo), zinc (Zn), nickel (Ni), and combinations thereof. In fertilizer, the nutrients, such as those listed above, do not have to be in elemental form, but may be in the form of a salt or as a compound (e.g., urea).

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include ranges within 10%, within 5%, within 1%, or within 0.5%.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The use of the words “a” or “an” when used in conjunction with any of the terms “comprising”, “including”, “containing”, or “having” in the claims or the specification may mean “one,” but it is also consistent with the meaning of “one or more”, “at least one”, and “one or more than one.”

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The controlled-release fertilizer composition of the present invention and uses thereof can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the controlled-release fertilizer composition of the present invention is the slow-release of fertilizer from the three-dimensional composite open-celled network of graphene and carbon nanotubes.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a non-limiting illustration of a structural representation of a composite graphene-carbon nanotube material.

FIG. 2 is a scanning electron microscope (SEM) image of a graphene-carbon nanotube three-dimensional open-celled foam of the present invention having a 0.5:1 weight ratio of graphene to carbon nanotubes.

FIG. 3 illustrates the distribution of urea after being released in soil at 10° C. using the controlled-release fertilizer composition of the present invention.

FIG. 4 illustrates the distribution of urea after being released in soil at 20° C. using the controlled-release fertilizer composition of the present invention.

FIG. 5 illustrates the distribution of urea after being released in soil at 30° C. using the controlled-release fertilizer composition of the present invention.

While the invention is susceptible to various modifications and alternative forms, specific embodiments thereof are shown by way of example in the drawings and may herein be described in detail. The drawings may not be to scale.

### DETAILED DESCRIPTION OF THE INVENTION

The present invention provides a control-release fertilizer composition and methods of using the composition. The composition includes fertilizer impregnated within a composite graphene/carbon nanotubes material that includes a three-dimensional network of interconnected pores and channels formed by the graphene and carbon nanotubes. The material has excellent thermal conductivity, which can promote effective absorption and release of one or more fertilizer(s). Use of the control-release fertilizer composition provides an elegant way for sustainable and efficient agriculture while mitigating and/or eliminating fertilizer pollution or costly repeated applications.

These and other non-limiting aspects of the present invention are discussed in further detail in the following sections with reference to the figures.

### A Controlled-Release Fertilizer Composition and Method of Making

Embodiments herein describe the controlled-release fertilizer compositions and methods of making the compositions. The controlled-release fertilizer compositions can include a composite graphene-carbon nanotube material having a three-dimensional open-cell network of graphene and carbon nanotubes, and a fertilizer. Impregnation of fertilizer in the three-dimensional open-celled network of graphene and carbon nanotubes provides an elegant way to provide controlled-release of fertilizer in amounts effective to achieve high absorption rates of nutrient salt substrates by plants. Due to the three-dimensional open-cell network of graphene and carbon nanotubes, significant amounts of fertilizer can be impregnated into the composite graphene-carbon nanotube material relative to the total weight of the controlled-release fertilizer composition. The ability to impregnate high doses of fertilizer into the composite that can be controllably released allows for fewer applications of fertilizer to a given crop. The controlled-release fertilizer composition can be packaged for commercial use (e.g., farms, etc.) or for individual consumer use (e.g., yards, etc.). Such packaging includes bags, containers, railcars, hoppers, etc.

In some embodiments, the fertilizer composition of the present invention can include 10 wt. % to 95 wt. % of fertilizer or at least, equal to, or between any two of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94 and 95 wt. % of fertilizer, based on the total weight of the controlled-release fertilizer composition. This high loading of fertilizer can be released in soil or water in a temperature-controlled and stable manner.

In a non-limiting method to produce a controlled-release fertilizer composition, the composite graphene-carbon nanotube material having a three-dimensional open-celled network of graphene and carbon nanotubes can be obtained as described below. Once formed, the composite three-dimensional composite graphene-carbon nanotube material can be combined with an aqueous fertilizer solution for a sufficient period of time to allow the aqueous solution to infiltrate the three-dimensional open-celled network of graphene and carbon nanotubes. The fertilizer impregnated composite graphene-carbon nanotube material can then be dried to obtain the controlled-release fertilizer of the present invention. The impregnation and drying steps can each be performed at a temperature of 5° C. to less than 100° C., preferably 10° C. to 50° C. or at least, equal to, or between any two of 5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 and 50° C. In certain aspects, the impregnation of fertilizer into the pores and channels of the composite graphene-carbon nanotube material can be performed at least, equal to, or between any two of 15° C., 20° C., 25° C., and 30° C., or more preferably at 20° C. to 25° C.

In certain aspects, the fertilizer of the present invention includes one or more nutrients. Nutrients can be in a salt form. Non-limiting examples of nutrient salts include aluminum sulfate, amino acid salt, ammonium chloride, ammonium molybdate, ammonium nitrate, ammonium phosphate, ammonium phosphate-sulfate, ammonium sulfate, borax, boric acid, calcium ammonium nitrate, calcium silicate, calcium chloride, calcium cyanamide, calcium nitrate, copper acetate, copper nitrate, copper oxalate, copper oxide, copper sulfate, diammonium phosphate (DAP), iron-ethylenediamine-N,N′-bis (Fe-EDDHA), iron-ethylenediaminetetraacetic acid (Fe-EDTA), elemental sulfur, ferric sulfate, ferrous ammonium phosphate, ferrous ammonium sulfate, ferrous sulfate, gypsum, humic acid, iron ammonium polyphosphate, iron chelates, iron sulfate, lime, magnesium sulfate, manganese chloride, manganese oxide, manganese sulfate, mono-ammonium phosphate (MAP), monopotassium phosphate, polyhalite, potassium bromide, potassium chloride (MOP), potassium nitrate, potassium polyphosphate, potassium sulfate, sodium chloride, sodium metasilicate, sodium molybdate, sodium nitrate, sulfate of potash (SOP), sulfate of potash-magnesia (SOP-M), single superphosphate (SSP), triple superphosphate (TSP), urea, urea formaldehyde, zinc oxide, zinc sulfate, zinc carbonate, zinc phosphate, and zinc chelate. Binary NP, NK, and PK fertilizers include two component fertilizers listed above containing compositions of nitrogen-phosphorus, nitrogen-potassium, and phosphorus-potassium respectively. Ternary NPK fertilizers include nitrogen, phosphorus, and potassium and superphosphates compounds. Super phosphated compounds can include single superphosphate (SSP) and triple superphosphate (TSP) compounds. A mixture of SSP and TSP compounds is referred to as double superphosphate (DSS) compounds. In some aspects, the fertilizer composition can include combinations of these salts and/or non-salt forms of the above-listed nutrients, among others. In preferred aspects, the at least one nutrient salt can include urea, ammonium nitrate, calcium ammonium nitrate, one or more superphosphates, a binary NP fertilizer, a binary NK fertilizer, a binary PK fertilizer, a NPK fertilizer, molybdenum, zinc, copper, boron, cobalt, or iron, or any combination thereof. In a specific aspect, at least one nutrient salt includes urea. Fertilizers are commercially available from many sources. A non-limiting example of a source of urea is Sinopharm Chemical Reagent Co., Ltd. (Shanghai, China).

### B. Composite Graphene-Carbon Nanotube Materials and Preparation Thereof

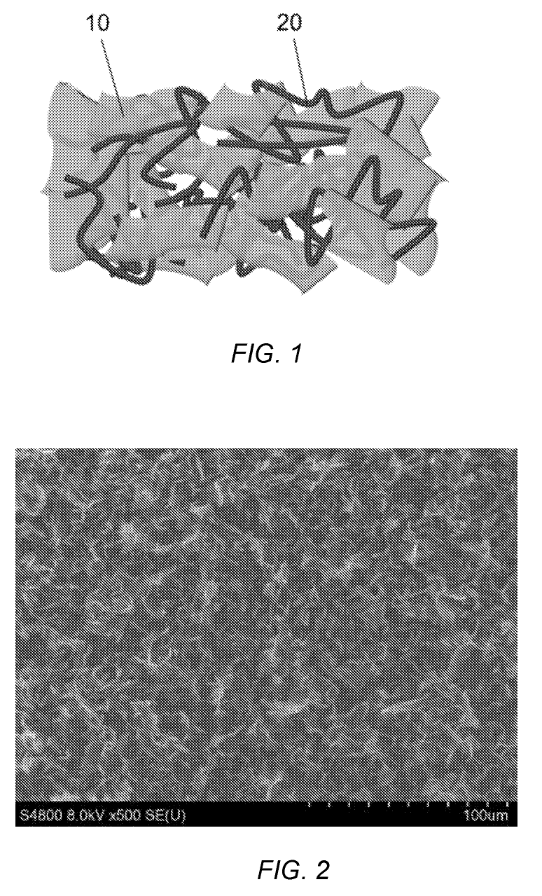

The composite graphene-carbon nanotube material of the present invention can have various three-dimensional structural arrangements. FIG. 1 depicts a non-limiting structural representation of a composite graphene-carbon nanotube material. As shown, graphene 10 and carbon nanotube 20 form a randomly orientated composite having three-dimensional structure. Further non-limiting examples of three-dimensional structural arrangements can include a foam, a honeycomb, a mesh, and the like. In a preferred embodiment, the composite graphene-carbon nanotube material has a three-dimensional open cell network. Without being limited by theory, it is believed that the graphene and carbon nanotubes are coupled together in the composite graphene-carbon nanotube material by van der Waal forces. It is also believed that the piling of the graphene and the carbon nanotubes forms a three-dimensional network skeleton, resulting in pores and channels that are in mutual communication that can effectively implement absorption and release of fertilizers.

The mass (weight) ratio of graphene to carbon nanotubes in the composite graphene-carbon nanotube material can be 0.1:1 to 5:1, preferably 0.5:1 to 2:1 or at least, equal to, or between any two of 0.1:1, 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1 and 2:1. By adjusting the mass ratio of the graphene to carbon nanotubes used to make the composite controlled-release material, several properties can be tuned. For instance, the thermal conductivity of the composition can be optimized to 0.8 mW/m.K when the mass ratio of the graphene to carbon nanotubes is adjusted to 1.3:1. The three-dimensional (3-D) open-celled foam structure can include pores and channels. The pore structure of the foam can be uniform, or disordered, and have a variety of pore and channel sizes. In preferred aspects, at least one pore and/or channel of the controlled-release three-dimensional open-celled network can have a diameter from 1 to 100 microns, preferably 2 to 50 microns or at least, equal to, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 70, 80, 90, and 100 microns. The pore volume can be from 0.5 to 2.5 cm³/g or at least, equal to, or between any two of 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, and 2.5 cm³/g, preferably 1 to 2 cm³/g, more preferably 1.5 to 1.8 cm³/g. The specific surface area of the graphene-carbon nanotube material of the present invention can be 50 m²/g to 300 m²/g, preferably 200 m²/g.

The composite graphene-carbon nanotube material of the present invention advantageously has a thermal conductivity that allows for release of the fertilizer based on temperature. In some embodiments, the thermal conductivity can be least 0.2 mW/m.·K at a temperature of 20° C. to 80° C., preferably a thermal conductivity of 0.3 mW/m.·K to 0.8 mW/m.·K and all thermal conductivities and ranges at least, equal two or between any two of 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79 and 0.80 mW/m.·K at a temperature of 25° C. to 60° C. and all temperatures of at least, equal to, or between any two of 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 and 60° C. Thermal conductivities can be measured by a Hot Disk Instruments TPS 2500S (Hot Disk AB, Sweden) via a steady-state method at ambient pressure and at a temperature ranging between 20° C. and 80° C.

In one instance, preparation of the controlled-release graphene-carbon nanotube composite of the present invention can include dispersion and/or distribution of the carbon nanotubes onto the surface of graphene sheets (e.g., piling).

Graphene is an ultra-thin and ultra-light layered carbon material forming a two-dimensional honeycomb lattice with high mechanical strength, super conductivity, and high specific surface area. The graphene contained in the composite graphene-carbon nanotube material of the present invention can include a plurality of planar graphene sheets. In another aspect, the graphene is not functionalized. Graphene is commercially available from many sources. A non-limiting example of a source of graphene is Ningbo Morsh Tech. Co., Ltd., (China).

Carbon nanotubes (CNTs) are nanometer-scale tubular-shaped graphene structures that have high specific surface area, excellent thermal conductivity, electrical conductivity, and excellent mechanical properties. CNTs have also been shown to be highly resistant to fatigue, radiation damage, and heat. Carbon nanotubes (CNTs) can have a variety of structural forms, thereby allowing tuning or designing of the chemical and/or physical properties pertaining to the environment that the fertilizer is to be released. The CNTs contained in the controlled-release fertilizer composition of the present invention can be single-walled carbon nanotubes (SWNTs), double-walled carbon nanotubes (DWNTs), triple-walled carbon nanotubes (TWNTs), multi-walled carbon nanotubes (MWNTs), graphenated carbon nanotubes (g-CNTs), nitrogen-doped carbon nanotubes (N-CNTs), or combinations thereof. Preferably, the CNTs are multi-walled carbon nanotubes (MWNTs). CNTs are commercially available from many sources. A non-limiting example of a commercial source of MWCNTs is Shandong Dazhan Nanomaterials Co., Ltd., (China).

In one embodiment, carbon nanotubes can be precipitated from a solution in the presence of graphene, followed by drying. In another embodiment, graphene and carbon nanotubes can be mixed together in solid form, dissolved, or suspended together in a suitable solvent. The solution can be agitated (e.g., stirred and/or sonicated) and the solvent can be removed (e.g., through evaporation). In a preferred aspect, the composite graphene-carbon nanotube material can be obtained by lyophilization (i.e., freeze drying) of an aqueous mixture of graphene and carbon nanotubes. In the lyophilization method, both graphene and carbon nanotubes of a predetermined concentration (e.g., a mass ratio of graphene to carbon nanotubes of 0.5:1, 1:2, or 2:1) can be dispersed in an aqueous medium or solution. The dispersion can be stirred, sonicated, and/or heated to ensure even distribution or homogeneity, and then subjected to freezing conditions (e.g., −200 to −60° C.) to form a frozen material. The frozen material can be dried at less than about −60° C. and a vacuum of about 1.3 to 13 Pa to remove the water and form the open-cell structure (e.g., lyophilized in a conventional freeze-drying apparatus). The resulting graphene-carbon nanotube open-cell structures can be collected.

In some embodiments, the composite graphene-carbon nanotube materials can be reduced in size (e.g., macronized, micronized or nanosized), using known sizing methods (e.g., granulation or powderification). In any of the above methods, the materials may be mixed together using suitable mixing equipment. Examples of suitable mixing equipment include tumblers, stationary shells or troughs, Muller mixers (for example, batch type or continuous type), impact mixers, and any other generally known mixers, or generally known devices that can suitably provide dispersion of the graphene and the carbon nanotube. For solution chemistries, a mechanical stirrer, or sonification can be used.

### C. Use of Controlled-Release Fertilizer Composition

Methods of using the controlled-release fertilizer composition of the present invention are described. A method can include applying the controlled-release fertilizer to soil (e.g., for renewable agricultural purposes). Preferably, the controlled-release fertilizer composition is applied to the soil at a depth of at least 2 cm from the soil surface, more preferably a depth of 2 cm to 15 cm, or most preferably 5 to 12 cm, and all depths of at least, equal to, or between any two of 2, 3, 4, 5, 6, 7, 8, 9, 10, 11, 12, 13, 14, and 15 cm from the soil surface. By way of example, the soil can be tilled or cultivated using mechanical agitation (e.g., dug, stirred, overturned, or the like) and the controlled-release fertilizer applied to the tilled soil using a spreader, and then covered by the soil. In other embodiments, the fertilizer can be added at the time of planting of crops or seeding of a field. The fertilizer can be controllably released from applied controlled-release fertilizer composition in response to at least ground temperature and provide nutrients over time without significant leaching of fertilizer or loss of nutrients.

The impregnated fertilizer contained within the pores, channels, or both, of the open-celled network can be controllably-released. The release temperature of the fertilizer can be 0° C. to 40° C., preferably 10° C. to 30° C. and temperatures of at least, equal to, or between any two of 0, 5, 10, 11, 12, 13, 14, 15, 16, 17, 18, 19, 20, 21, 22, 23, 24, 25, 26, 27, 28, 29, 30, 35, and 40° C. The efficient release of impregnated fertilizer can be due in part, to the high thermal transport or heat transfer within the composite graphene-carbon nanotube material. This thermal transport or heat transfer known as thermal conductivity can be measured quantitatively by processes known by those of ordinary skill in the art. In some aspects, an increase in ambient temperature results in an increase in fertilizer release such the controlled-release fertilizer of the present invention can be used to release fertilizer at a rate that corresponds with temperature dependent agriculture growth cycles. In some embodiments, the controlled-release fertilizer composition having a composite can be used as a renewable fertilizer. By way of example, once the fertilizer is released, the composite graphene-carbon nanotube material can be collected and recharged. In non-limiting aspects, the controlled-release fertilizer can be provided as granules, pellets, nodules, plates, stakes, rods, cubes, chunks, etc., that may be contained within a permeable container for convenient application, storage, and retrieval.

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

Graphene was obtained from Ningbo Morsh Tech. Co., Ltd., China. Multi-walled carbon nanotubes (MWCNT) were obtained from Shandong Dazhan Nanomaterials Co., Ltd., China. Urea (>99%) was obtained from Sinopharm Chemical Reagent Co., Ltd., Shanghai, China. Urea concentration in the soil was measured using a spectrophotometry method using a chromogenic reagent (i.e., p-dimethylaminobenzaldehyde) after leaching soil with water.

### Example 1

### Preparation of a Composite Graphene-Nanocarbon Material

Graphene and carbon nanotubes (0.5:1, 1:1, or 2:1 wt:wt) were added to water (1000 mL) to form a suspension. The suspension was then frozen in liquid nitrogen and placed under vacuum and held at cryogenic temperature (about −60° C.) to sublime off the frozen water until a dry solid composite foam having the above provided ratios of graphene to carbon nanotubes remained. FIG. 2 shows an SEM of the 0.5:1 graphene-carbon nanotube three-dimensional composite foam. The thermal conductivity of the composite foam was 0.5 mW/m.K, pore volume was 1.2 cm³/g, and specific surface area was 212 m²/g.

### Example 2

### Impregnation of the Composite Material with Urea and Urea Release Testing

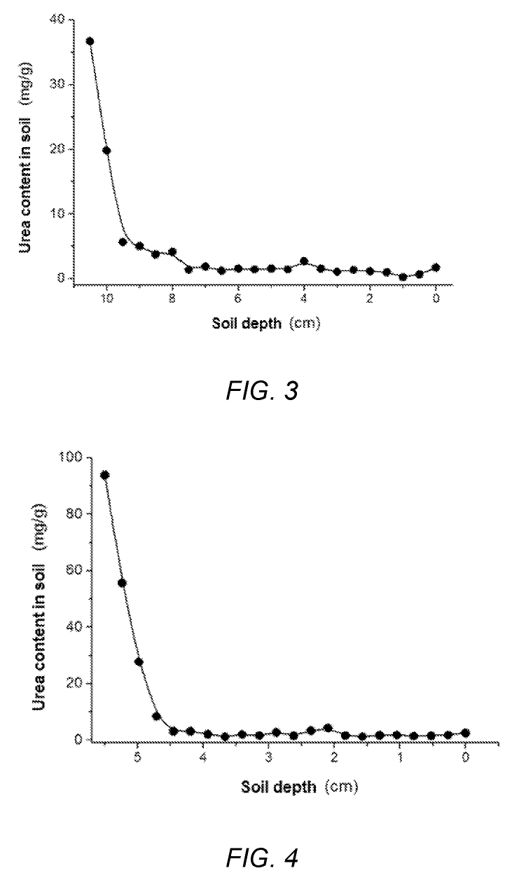

Urea (54 g) was added to water (100 g) under stirring to obtain a saturated urea solution. Graphene-carbon nanotube three-dimensional composite foam (10 g, 0.5:1 from Example 1) was immersed in the saturated urea solution overnight at room temperature, removed from the solution, and then dried in air overnight at room temperature. The resultant impregnated foam was buried in soil at a depth of 11 cm from the surface. The soil was maintained at 10° C. and the urea content of the soil was monitored over a 3 day period. FIG. 3 shows the urea content at different depths in the soil. As determined from the data, the urea was gradually released from the graphene-carbon nanotube composite foam into the soil at a total release rate of 9%, which was lower than 15% for the blank control experiment without composite foam.

### Example 3

### Impregnation of the Composite Material with Urea and Urea Release Testing

Urea (54 g) was added to water (100 g) under stirring to obtain a saturated urea solution. Graphene-carbon nanotube three-dimensional composite foam (8 g, 1:1 from Example 1) was immersed in the saturated urea solution overnight at room temperature, removed from the solution, and then dried in air overnight at room temperature. The resultant impregnated foam was buried in soil at a depth of 5 cm from the surface. The soil was maintained at 20° C. and the urea content of the soil was monitored over a 3 day period. FIG. 4 shows the urea content at different depths in the soil. As determined from the data, the urea was gradually released from the graphene-carbon nanotube composite foam into the soil at a total release rate of 16%, which was lower than 28% for the blank control experiment without composite foam.

### Example 4

### Impregnation of the Composite Material with Urea and Urea Release Testing

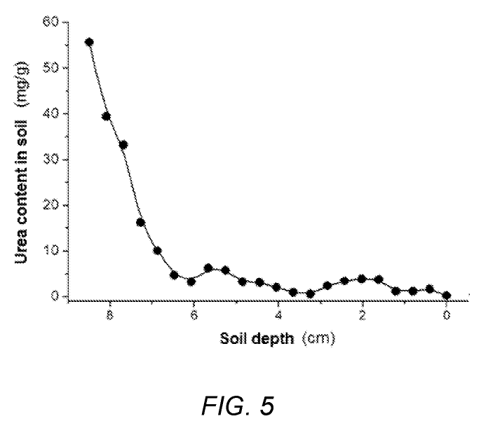

Urea (54 g) was added to water (100 g) under stirring to obtain a saturated urea solution. Graphene-carbon nanotube three-dimensional composite foam (5 g. 2:1 from Example 1) was immersed in the saturated urea solution overnight at room temperature, removed from the solution, and then dried in air overnight at room temperature. The resultant impregnated foam was buried in soil 11 cm from the surface. The soil was maintained at 30° C. and the urea content of the soil was monitored over a 3 day period. FIG. 5 shows the urea content at different depths in the soil. As determined from the data, the urea was gradually released from the graphene-carbon nanotube composite foam into the soil at a total release rate of 36%, which was lower than 49% for blank control experiment without composite foam.

It can be seen from the above examples that the release rate of urea in the graphene-carbon nanotube composite foam was lower than the controls. As the ambient temperature of the soil increases, the release rate increases, indicating that the controlled release of a fertilizer can be achieved by adjusting the ambient temperature of the soil.

1. A controlled-release fertilizer composition comprising:
(a) a composite graphene-carbon nanotube material having a three-dimensional open-celled network of graphene and carbon nanotubes; and
(b) a fertilizer impregnated within the three-dimensional open-celled network of graphene and carbon nanotubes.

2. The controlled-release fertilizer composition of claim 1, wherein the mass ratio of graphene to carbon nanotubes is 0.1:1 to 5:1.

3. The controlled-release fertilizer composition of claim 1, wherein the composite graphene-carbon nanotube material is a monolith network of graphene and carbon nanotubes having an open-celled foam structure.

4. The controlled-release fertilizer composition of claim 1, wherein the controlled-release three-dimensional open-celled network comprises pores and channels.

5. The controlled-release fertilizer composition of claim 4, wherein the diameter of the pores and channels is 1 to 100 microns.

6. The controlled-release fertilizer composition of claim 1, wherein the graphene comprises a plurality of planar graphene sheets.

7. The controlled-release fertilizer composition of claim 1, wherein the carbon nanotubes are single walled carbon nanotubes, multi-walled carbon nanotubes, or a combination thereof, preferably multi-walled carbon nanotubes.

8. The controlled-release fertilizer composition of claim 1, wherein the fertilizer is controllably released from the composite graphene-carbon nanotube material in response to at least temperature.

9. The controlled-release fertilizer composition of claim 8, wherein the release temperature of the fertilizer is 0° C. to 40° C.

10. The controlled-release fertilizer composition of claim 1, wherein the composite graphene-carbon nanotube material has a thermal conductivity of at least 0.2 milliwatts per meter Kelvin (mW/m·K) at a temperature of 20° C. to 80° C.

11. The controlled-release fertilizer composition of claim 1, wherein the fertilizer comprises urea, ammonium nitrate, calcium ammonium nitrate, one or more superphosphates, molybdenum, zinc, copper, boron, cobalt, iron, a binary nitrogen and phosphorous (NP) fertilizer, a binary nitrogen and potassium (NK) fertilizer, a binary phosphorous and potassium (PK) fertilizer, or a ternary nitrogen, phosphorous, and potassium (NPK) fertilizer, or any combination thereof.

12. The controlled-release fertilizer composition of claim 1, wherein the fertilizer composition is comprised in soil.

13. The controlled-release fertilizer composition of claim 1, comprising 10 wt. % to 95 wt. % of fertilizer, based on the total weight of the controlled-release fertilizer composition.

14. A method of fertilizing soil, the method comprising applying the controlled-release fertilizer composition of claim 1 to soil.

15. The method of claim 14, wherein the controlled-release fertilizer composition is applied to the surface of the soil.

16. The method of claim 14, wherein the fertilizer is controllably released from the composite graphene-carbon nanotube material in response to at least temperature.

17. The method of claim 16, wherein the release temperature of the fertilizer is 0° C. to 40° C.

18. A method of making the controlled-release fertilizer composition of claim 1, the method comprising:
(a) obtaining a composite graphene-carbon nanotube material having a three-dimensional open-celled network of graphene and carbon nanotubes;
(b) combining the composite graphene-carbon nanotube material with an aqueous solution comprising a fertilizer for a sufficient period of time to allow the aqueous solution to infiltrate the three-dimensional open-celled network of graphene and carbon nanotubes; and
(c) drying the composite graphene-carbon nanotube material from step (b) to obtain the controlled-release fertilizer composition.

19. The method of claim 18, wherein steps (b) and (c) are each performed at a temperature of 5° C. to less than 100° C.

20. The method of claim 18, wherein the composite graphene-carbon nanotube material from step (a) is obtained by lyophilizing an aqueous mixture of graphene and carbon nanotubes.
